(19) United States
(12) Patent Application Publication
(10) Pub. No.: US 2025/0114178 A1
(43) Pub. Date: Apr. 10, 2025

(54) ORAL CLEANSING DEVICE

(71) Applicant: Mansur Abahusayn, Mission Viejo, CA (US)

(72) Inventor: Mansur Abahusayn, Mission Viejo, CA (US)

(21) Appl. No.: 18/481,994

(22) Filed: Oct. 5, 2023

(51) Int. Cl. A61C 17/02; A61C 17/024; A61C 17/032

(52) U.S. Cl. CPC A61C 17/0202; A61C 17/024; A61C 17/032

(57) ABSTRACT

An oral irrigator includes a flexible inlet water tube that may be passed through a magnet assembly to treat the water as it passes through the tube. The magnet assembly may include a number of discs including a magnetic material which are separated by spacers of a non-magnetic material such as a plastic. The magnets and separators may have an aperture in the center to accommodate the inlet water tube. The oral irrigator may include a tip that provides a thread-like stream of water. The pressure of this stream may be due in part to the internal structure of the irrigator tip in which the diameter of an internal water channel gradual narrows until it reaches and is ejected from an orifice at a distal end of the tip. The oral irrigator may receive water from a water tank or a direct connection to a house water supply.

### TECHNICAL FIELD

The technical field of the disclosed embodiments relate to the field of oral cleansing devices. More particularly, the disclosed embodiments relate to a device which facilitates oral cleansing by way of a jet stream of water which has been subjected to a magnetic field.

### BACKGROUND

Oral irrigation devices perform the function of oral cleansing by way of a variable pressure stream of fluid. These devices are designed to cleanse the mouth using water pressure to irrigate food and other debris from between the teeth and gums.

A well known device is the WATERPIK® oral irrigator (U.S. Pat. Nos. 4,302,186;4,229,634; 4,337,040; and 4,989,590). Most WATERPIK® systems make use of electricity in order to power an internal pump. Once the pump is activated, water or other liquid is extracted from a reservoir and ejected at relatively high pressure in order to flush particulate matter from the teeth and gums. The reservoir is included with the WATERPIK® system, and is designed to hold enough water or other cleaning fluid to last through several cleanings using the WATERPIK® system.

A potential problem with the WATERPIK® system is the possibility of extremely high water pressure being delivered to a user's delicate gum tissue and oral cavity. Although some models of the WATERPIK® system have a dial by which a user may adjust the pressure at which fluid is ejected, there is potential for the dial to become maladjusted; a user may also overestimate the desired pressure, thereby delivering a stream of fluid that may cause injury and bleeding gums. Another conceivable problem with the WATERPIK® system may occur if children have access to the system; medium to high pressure streams of cleaning fluid may cause damage the tender gums or teeth of a child. Also, with known oral irrigators, the stream of water ejected from the orifice of the tip of the irrigator may spray or splatter into droplets, decreasing the effectiveness of the stream of water in cleaning the user's teeth and gums. What is therefore needed is an oral cleansing device which is safe and gentle yet effective for oral cleansing and hygiene of both adults and children.

### SUMMARY

Disclosed are various embodiments of an oral irrigator including a flexible inlet water tube that may be passed through a magnet assembly to treat the water as it passes through the tube and provide other benefits for users' oral hygiene regimen. The magnet assembly may include a number of discs including a magnetic material which are separated by spacers (or “separators”) of a non-magnetic (inert) material such as a plastic. The magnets and separators may have an aperture in the center to accommodate the inlet water tube.

The magnet assemble may be secured to the inlet tube by top and bottom spacers with narrow diameters which provide a tight, but not constrictive, engagement with the inlet tube. Alternatively, or in addition, a water filter in the tube may prevent magnet assembly from sliding off of the tube, where the water filter has a diameter sufficient to stretch the portion of the tube it occupies to a diameter greater than the apertures in the magnets and/or spacers.

The oral irrigator may include a tip that provides a non-splattering and thread-like stream of water. The pressure of this stream may be due in part to the internal structure of the irrigator tip. As pressurized water, e.g., from a pump in a body of the oral irrigator, enters a water channel (or path) at the proximal end of the tip (i.e., the end connected to the body), the water channel gradually narrows until it reaches and is ejected from an orifice at a distal end of the tip. This change in internal diameter automatically increases the pressure of the water to produce a fine, narrow, and thread-like stream, avoiding scattering of the ejected water into individual droplets.

### BRIEF DESCRIPTION OF THE DRAWINGS

FIG. 1 is a perspective side view of a magnetic oral irrigator according to an embodiment.

FIG. 2 is a sectional view of a magnetic assembly including a water carrying inlet tube according to an embodiment.

FIG. 3 is a sectional view of an oral irrigator tip according to an embodiment.

FIG. 4 is a partial section view of a direct connection for an oral irrigator to a house water supply according to an embodiment.

### DETAILED DESCRIPTION

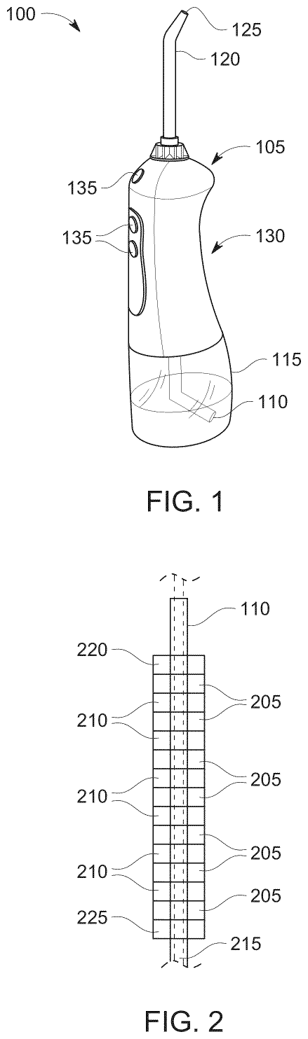

FIG. 1 shows a portable magnetic oral irrigator 100 according to an embodiment. The irrigator 100 may include a body 105, a water inlet tube 110, a water tank 115, e.g., a bottle-or cup-like structure, and a tip 120 including an orifice 125 to eject a thin, thread-like stream of water.

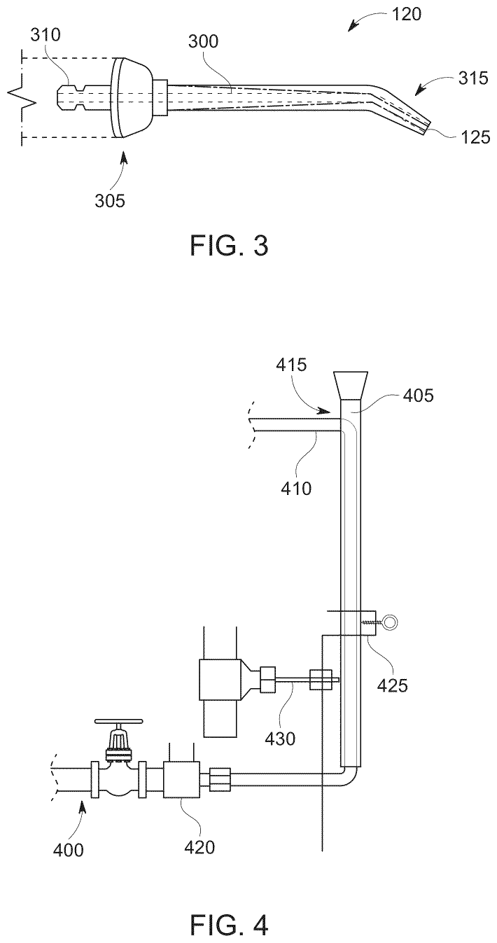

The tip 120 may be detachably connected to the top of the body 105 using various types of attachment mechanisms, for example, push-in connector (FIG. 3), screw-on (threaded) connector, twist lock, etc. The water tank 115 may also be detachably connected to the bottom of the body 105. The inlet tube 110 permits water to flow from the water tank 115 to the orifice 125.

The body 105 may have a shape adapted to be easily gripped by a user's hand, and may include a grip portion 130 and control buttons 135, for example, a power button, water pressure control buttons, etc. The control buttons 135 can be positioned to be easily operated by the user, e.g., with their thumb, when operating the irrigator 100.

The body 105 may house other components, including a portion of the inlet tube 110, a pump with a power source, and a control module to power on/off the pump and control the desired water pressure provided by the pump in response to the user operating the control buttons 135.

The irrigator 100 may utilize the phenomenon of the effect of a magnetic field on dispersing and fragmentation of hard deposits of calcium, magnesium-iron carbonates, and sulfates that accumulate around the gums of teeth and may not be removed by brushing or standard flossing. Also, subjecting the water to a magnetic field as it flows through the irrigator may cause a change in the resonance, polarity, and/or ionization of the water molecules such that the water has de-scaling capabilities as a result. For example, the instantaneous resonance of the water molecule H—O—H when subjected to a magnetic field, which lasts for a few seconds, may destabilize the structure of the mineral deposits. Such de-scaling may not be possible solely by tooth brushing, but with the assistance of the oral irrigator, de-scaling of the hard mineral deposits on the teeth may occur over time, e.g., in a few months.

As shown in FIG. 2, a portion of the inlet tube 110 is strung through a magnet assembly 200 including a number of stacked magnets 205 which may be sized and arranged to provide a desirable magnetic effect with the least number and strength of magnets. The magnets 205 may be disc-like with a hole in the middle.

In an embodiment, a number of magnets 205, for example, seven, made from magnetic materials, are stacked with a separation between every two magnets. This separation between adjacent magnets may be provided by an inert disc, or separator, 210 made of FDA approved material that does not rust. Each of the magnets 205 and separators 210 may have an outer diameter of 25 mm, thickness of 6.35 mm, and and inner diameter of 9.8 mm. The flexible inlet tube 110 may have an outer diameter of 4.76 mm and inner diameter of 3.175 mm and be provided through the holes in the magnets 205 and separators 210.

In an embodiment, two inert discs may be provided at the top and bottom of the magnet assembly 200. These inert discs (top 220 and bottom 225) may made of the same material and have the same outer diameter and thickness of the separators 210, but have a smaller inner diameter, e.g., 4.8 mm, to provide a relatively tight fit with the outer diameter of the inlet tube 110 and hold the strung magnets and their separators tightly in place. Alternatively, or in addition, the strung magnets and separator assembly may be prevented from sliding out of the inlet tube 110 by a filter insert 215 at the water entry portion of the inlet tube as its diameter is larger than the diameter of the holes (inner diameter) of the magnets and separators.

FIG. 3 shows the tip 120 according to an embodiment. The tip 120 is configured to eject a clean, non-splattering and non-pulsating stream of water from the orifice 125 of the tip. This may be achieved by the gradual narrowing of the water path 300 inside the tip 120 from a proximal end 305 of the tip where it connects to the body 105 via a connector 310 toward the orifice 125 at a distal end 315 so that when water exits the orifice 125, the water is ejected with a fairly strong pressure to generate a threadlike stream of water that resembles dental floss. This pressure may be generated by the narrowing of the water path as it flows toward the orifice exit, causing the pressure of the water entering the tip to increase due to the conservation of energy and mass. As used herein, the term “gradual” may indicate a continuous narrowing of the diameter or a narrowing in multiple stages. However, the overall effect is to prevent high changes in pressure at the orifice to prevent scattering of the water into droplets while still providing an increase in water pressure from the entry of the tip (proximal end) to the orifice (distal end).

The straight, thread-like stream of water that strikes the teeth and gums provided by the irrigator 100 may be advantageous as the steam of water emitted by other oral irrigators in the market that scatter and/or break into individual drops of water. This may occur because the orifice of such irrigator tips is merely a pinhole and without the gradually narrowing water path, the sudden pressure change as the water exits the tip orifice breaks the water into splatter rather than a thread-like stream. Also, some other oral irrigators provide a pulsation of emitted water. Pulsated water exits the orifice of the tip in squirts of water and, like a scattered stream, loses the benefits of threadlike floss shape of the stream that dislodges debris and massages gums more effectively.

In an embodiment, the tip 120 may be about 100 mm long. The tip may have an internal water path with a diameter that gradually narrows from the proximal end 305 of the tip 120 to the orifice 125. In an embodiment, the diameter of the orifice 125 may be in a range of 0.1 mm to 1.5 mm, for example, 0.5 mm. The diameter of the internal water path at the proximal end of the tip may be in a range of five to twenty-five times larger than the diameter of the oriface 125. The connector 310 may be push-in type compatible with other oral irrigators.

In operation, the tip may be held about 15 cm from the teeth when cleaning.

The material of the tip 120 and tubing 110 may be made of FDA approved transparent material. The tip 120 may be made of a hard and transparent material such as polycarbonate. The tubing may be made of a flexible and transparent material such as polyethylene terephthalate (PET). The advantage of both the tip and tubing being transparent is to enable the user see potential debris coming from the water source that may restrict flow and needs to be cleaned occasionally. Cleaning may be done by removing the tip from the oral irrigator body 105 and flushing it with water, e.g., from a faucet. The tubing can be cleaned in a similar manner.

In an alternative embodiment, rather than using an electric pump, the irrigator may be connected directly to a water source in the user's house (or apartment, hotel room, etc.), for example, the bathroom sink without attachment to the faucet. Such an arrangement ensures flow of clean fresh water directly from the house water supply without the need for a water tank attached to the body which may require frequent cleaning. The operation of the irrigator directly connected to the house water supply eliminates the need for batteries and the pump, which may consitute an appreciable part of the manufacturing cost and maintenance.

As shown in FIG. 4, the direct connection of an irrigator to the house water supply 400 at the bathroom sink may be achieved by replacing the lift rod used to lift and lower the sink plug with a hollow steel stem 405 through which the tubing 410 is threaded. The tubing may be straight or coiled.

A hole 415 may be provided in the hollow steel stem for the tubing entry. The tubing may then be connected underneath the sink to the water source through a tee fitting 420. A clevis screw 425 and pivot rod 430 configuration may be employed to control the action of the drain plug and the release of water through the tubing to the irrigator.

A mouth wash solution may be included in a bottle that is connected to the tubing through a Venturi tube which can suck the mouthwash solution from the bottle when a valve is opened by the user when finished cleaning their teeth with water.

The irrigator 100 may be portable, only needing a clean source of water. When used by hotels, motels, bed & breakfast inns, etc., the irrigator may be strapped to the faucet to prevent theft. Alternatively, the irrigator may be charged to the client just as done with sheets, towels, bath robes and the like if removed from the premises when the guest checks out. Where the irrigator is offered as a service, extra tips 120 may be made available for a small charge or as an additional service.

### REFERENCE NUMBERS FOR THE DISCLOSED EMBODIMENTS

100 oral irrigator
105 irrigator body
110 inlet tube
115 water tank
120 irrigator tip
125 tip orifice
130 grip portion
135 control buttons
200 magnet assembly
205 magnet
210 separator (inert disc)
215 filter insert
220 top inert disc
225 bottom inert disc
300 water path (tip)
305 proximal end (tip)
310 connector
315 distal end (tip)
400 house water supply
405 hollow stem
410 tubing
415 hole in hollow stem
420 tee
425 clevis screw
430 pivot rod

The foregoing method descriptions and figures are provided as illustrative examples only. The order of operations in the aspects described herein may be performed in any order. Words such as “thereafter,” “then,” “next,” etc. are used to guide the reader through the description of the methods and systems described herein, and do not limit the order of the operations. Any reference to claim elements in the singular, for example, using the articles “a,” “an,” or “the” is not to be construed as limiting the element to the singular. Also, relative terms such as “top,” “bottom,” “upper,” “lower,” “above,” “below,” and the like as used herein describe the relative positions of elements or features, and are not limited to the orientations depicted in the drawings. Furthermore, the specific dimensions, materials, and other details, such as the number of magnets, set forth with regard to specific embodiments are for illustrative purposes only and are not intended to limit the scope of the claims.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the specific embodiments described herein but is to be accorded the widest scope consistent with the claims.

1. An oral irrigator comprising:
a body having a first end and a second end;
a magnet assembly including
a plurality of magnetic elements, each magnetic element having an internal aperture,
a plurality of non-magnetic elements, each non-magnetic element having an internal aperture, wherein adjacent magnetic elements are separated by one of said plurality of non-magnetic elements;
a fluid inlet tube provided through the apertures of said plurality of apertures in the magnetic elements and non-magnetic elements in the magnet assembly;
a tip including
a distal end configured to enable the tip to be detachably connected to the first end of the body,
a proximal end including an orifice having a width, and
a water channel extending between the proximal end and the distal end, wherein a width of the of the water channel at the proximal end is in a range of five to twenty-five times greater than the width of the orifice.

2. The oral irrigator of claim 1, further comprising a water tank detachably connected to the second end of the body.

3. The oral irrigator of claim 1, wherein the plurality of magnetic elements and plurality of non-magnetic elements have a disc shape and the aperture comprises a circular hole.

4. The oral irrigator of claim 3, wherein the plurality of non-magnetic elements include a pair of end elements configured to secure the magnet assembly to the inlet water tube.

5. The oral irrigator of claim 1, further comprising a water filter.

6. The oral irrigator of claim 1, wherein the plurality of magnetic elements comprise three or more magnetic elements.

7. The oral irrigator of claim 1, further comprising:
a hollow lift rod, wherein a portion of the inlet tube is positioned in said rod; and
a house water supply connection connected to the inlet tube.

8. An oral irrigator tip comprising:
a distal end configured to enable the tip to be detachably connected to the first end of the body;
a proximal end including an orifice having a width; and
a water channel extending between the proximal end and the distal end, wherein a width of the of the water channel at the proximal end is in a range of five to twenty-five times greater than the width of the orifice.
